(19) United States
(12) Patent Application Publication
(10) Pub. No.: US 2023/0113387 A1
(43) Pub. Date: Apr. 13, 2023

(54) CALIBRATION SYSTEM, METHOD FOR CONTROLLING THE SAME, AND CONTROL PROGRAM

(71) Applicant: TOYOTA JIDOSHA KABUSHIKI KAISHA, Toyota-shi (JP)

(72) Inventors: Suomi TANISHIGE, Tokyo (JP); Takuya IKEDA, Tokyo (JP)

(21) Appl. No.: 17/938,694

(22) Filed: Oct. 7, 2022

(30) Foreign Application Priority Data
Oct. 12, 2021 (JP) 2021-167106

(51) Int. Cl. G06T 7/80; G06T 7/70

(52) U.S. Cl. CPC G06T 7/80; G06T 7/70

(57) ABSTRACT

A calibration system includes: a first calibration tool; a second calibration tool that is installed so as to be able to specify a relative position thereof with respect to the first calibration tool, the type of the second calibration tool being different from that of the first calibration tool; a first calibration target apparatus configured to be able to detect the first calibration tool; a second calibration target apparatus configured to be able to detect the second calibration tool; and an arithmetic processing apparatus configured to calculate the relative position of the second calibration target apparatus with respect to the first calibration target apparatus based on the result of detecting the first calibration tool by the first calibration target apparatus and the result of detecting the second calibration tool by the second calibration target apparatus.

### CROSS REFERENCE TO RELATED APPLICATIONS

This application is based upon and claims the benefit of priority from Japanese Patent Application No. 2021-167106, filed on Oct. 12, 2021, the disclosure of which is incorporated herein in its entirety by reference.

### BACKGROUND

The present discloses relates to a calibration system, a method for controlling the same, and a control program.

Japanese Unexamined Patent Application Publication No. 2015-161681 (Patent Literature 1) discloses an anchor structure constituting a marker arrangement for optical motion capture, in which two or more markers are arranged and fixed in spatial geometry. With this anchor structure, even when one marker is optically shielded from a camera, the position of the shielded marker can be calculated from the other markers.

### SUMMARY

It is considered that Patent Literature 1 assumes that markers are detected by a motion capture camera and does not assume that markers are detected by, for example, a camera such as an RGB camera which is a type of camera different from the motion capture camera, or an apparatus (a calibration target apparatus) such as a shape acquisition sensor other than a camera. Therefore, in Patent Literature 1, it is impossible to detect markers by using, for example, both the motion capture camera and the shape acquisition sensor. That is, in Patent Literature 1, it is impossible to detect markers by using a plurality of calibration target apparatuses of different types. This causes a problem that, in Patent Literature 1, it is difficult to specify a relative positional relation among a plurality of calibration target apparatuses of different types.

The present disclosure has been made in view of the aforementioned circumstances, and aims to provide a calibration system, a method for controlling the same, and a control program capable of specifying a relative positional relation among a plurality of calibration target apparatuses of different types.

A calibration system according to the present disclosure includes: a first calibration tool; a second calibration tool that is installed so as to be able to specify a relative position thereof with respect to the first calibration tool, the type of the second calibration tool being different from that of the first calibration tool; a first calibration target apparatus configured to be able to detect the first calibration tool; a second calibration target apparatus configured to be able to detect the second calibration tool; and an arithmetic processing apparatus configured to calculate the relative position of the second calibration target apparatus with respect to the first calibration target apparatus based on the result of detecting the first calibration tool by the first calibration target apparatus and the result of detecting the second calibration tool by the second calibration target apparatus. This calibration system further includes, besides the first calibration tool, the second calibration tool that is installed so as to be able to specify the relative position thereof with respect to the first calibration tool, the type of the second calibration tool being different from that of the first calibration tool. Accordingly, even in a case in which, for example, the types of the first and second calibration target apparatuses are different from each other, like a case in which the first calibration target apparatus is an RGB camera and the second calibration target apparatus is a motion capture camera or the like, the relative position of the second calibration target apparatus with respect to the first calibration target apparatus can be specified.

The first calibration target apparatus is at least one of a camera, a shape acquisition sensor, a position detection sensor, and a light-receiving element, and the second calibration target apparatus is at least one of a camera, a shape acquisition sensor, a position detection sensor, and a light-receiving element that is different from the first calibration target apparatus.

A coupling member configured to couple the first calibration tool to the second calibration tool may be further included. This coupling member allows the relative positional relation between the first and second calibration tools to be fixed.

A robot that couples the first calibration tool to the second calibration tool by a robot arm may be further included. The first and second calibration tools are coupled to each other by the robot arm whose angle or the like is adjusted by the robot, whereby it becomes possible to specify the relative position of the second calibration tool with respect to the first calibration tool.

The first calibration tool may be provided with a detection apparatus configured to be able to specify a relative position of the second calibration tool with respect to the first calibration tool by detecting the second calibration tool.

A first robot on which the first calibration tool is mounted and a second robot on which the second calibration tool is mounted may be further included.

At least one of the first and second robots may be configured so as to be movable. Accordingly, it becomes easy to install and remove the calibration tools. Further, the calibration tools can be installed in high or narrow places as well, whereby it becomes possible to apply the calibration system to a complicated environment.

A third calibration tool may be further provided, and the first calibration tool may be provided with a first detection apparatus configured to be able to specify a relative position of the third calibration tool with respect to the first calibration tool by detecting the third calibration tool, and the third calibration tool may be provided with a second detection apparatus configured to be able to specify a relative position of the second calibration tool with respect to the third calibration tool by detecting the second calibration tool.

A first robot on which the first calibration tool is mounted, a second robot on which the second calibration tool is mounted, and a third robot on which the third calibration tool is mounted may be further included.

At least one of the first to third robots may be configured so as to be movable. Accordingly, it becomes easy to install and remove the calibration tools. Further, the calibration tools can be installed in high or narrow places as well, whereby it becomes possible to apply the calibration system to a complicated environment.

A method for controlling a calibration system according to the present disclosure is a method for controlling a calibration system including: a first calibration tool; a second calibration tool that is installed so as to be able to specify a relative position thereof with respect to the first calibration tool, the type of the second calibration tool being different from that of the first calibration tool; a first calibration target apparatus configured to be able to detect the first calibration tool; a second calibration target apparatus configured to be able to detect the second calibration tool; and an arithmetic processing apparatus, the method including: detecting the first calibration tool by the first calibration target apparatus; detecting the second calibration tool by the second calibration target apparatus; and calculating, using the arithmetic processing apparatus, the relative position of the second calibration target apparatus with respect to the first calibration target apparatus based on the result of detecting the first calibration tool by the first calibration target apparatus and the result of detecting the second calibration tool by the second calibration target apparatus. In this method for controlling the calibration system, the calibration system further includes, besides the first calibration tool, the second calibration tool that is installed so as to be able to specify the relative position thereof with respect to the first calibration tool, the type of the second calibration tool being different from that of the first calibration tool. Accordingly, even in a case in which, for example, the types of the first and second calibration target apparatuses are different from each other, like a case in which the first calibration target apparatus is an RGB camera and the second calibration target apparatus is a motion capture camera or the like, the relative position of the second calibration target apparatus with respect to the first calibration target apparatus can be specified.

A control program according to the present disclosure is a control program of a calibration system, the calibration system including: a first calibration tool; a second calibration tool that is installed so as to be able to specify a relative position thereof with respect to the first calibration tool, the type of the second calibration tool being different from that of the first calibration tool; a first calibration target apparatus configured to be able to detect the first calibration tool; a second calibration target apparatus configured to be able to detect the second calibration tool; and an arithmetic processing apparatus, the control program causing a computer to execute the processing of: detecting the first calibration tool by the first calibration target apparatus; detecting the second calibration tool by the second calibration target apparatus; and calculating, using the arithmetic processing apparatus, the relative position of the second calibration target apparatus with respect to the first calibration target apparatus based on the result of detecting the first calibration tool by the first calibration target apparatus and the result of detecting the second calibration tool by the second calibration target apparatus. In this control program, the calibration system further includes, besides the first calibration tool, the second calibration tool that is installed so as to be able to specify a relative position thereof with respect to the first calibration tool, the type of the second calibration tool being different from that of the first calibration tool. Accordingly, even in a case in which, for example, the types of the first and second calibration target apparatuses are different from each other, like a case in which the first calibration target apparatus is an RGB camera and the second calibration target apparatus is a motion capture camera or the like, the relative position of the second calibration target apparatus with respect to the first calibration target apparatus can be specified.

According to the present disclosure, it is possible to provide a calibration system, a method for controlling the same, and a control program capable of specifying a relative positional relation among a plurality of calibration target apparatuses of different types.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a block diagram showing a configuration example of a calibration system according to a first embodiment;

FIG. 2 is a conceptual diagram showing a specific configuration example of the calibration system shown in FIG. 1;

FIG. 3 is a flowchart showing an operation of the calibration system shown in FIG. 1;

FIG. 4 is a diagram showing a configuration example of a calibration system according to a second embodiment;

FIG. 5 is a diagram showing a configuration example of a calibration system according to a third embodiment;

FIG. 6 is a diagram showing a modified example of the calibration system shown in FIG. 5;

FIG. 7 is a diagram showing a configuration example of a calibration system according to a fourth embodiment; and

FIG. 8 is a diagram showing a modified example of the calibration system shown in FIG. 7.

### DESCRIPTION OF EMBODIMENTS

Hereinafter, the present disclosure will be explained with reference to embodiments of the present disclosure. However, the disclosure set forth in the claims is not limited to the following embodiments. Further, not all the structures explained in the embodiments may be necessary as means for solving the problem. For a purpose of clarifying the description, the following description and the drawings will be omitted and simplified as appropriate. Throughout the drawings, the same components are denoted by the same reference symbols and overlapping descriptions will be omitted as necessary.

### First Embodiment

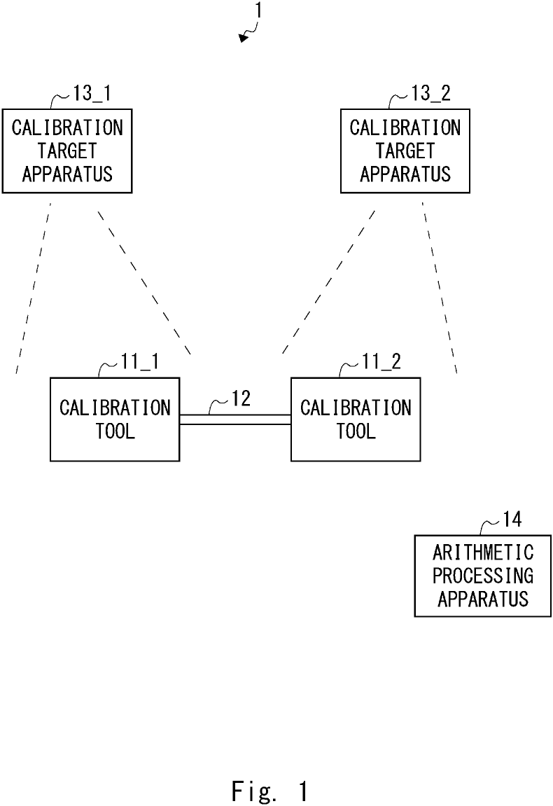

FIG. 1 is a block diagram showing a configuration example of a calibration system 1 according to a first embodiment. The calibration system 1 includes, besides a first calibration tool, a second calibration tool that is installed so as to be able to specify a relative position thereof with respect to the first calibration tool, the type of the second calibration tool being different from that of the first calibration tool, whereby even when the types of the first and second calibration target apparatuses are different from each other, the relative position of the second calibration target apparatus with respect to the first calibration target apparatus can be specified. Hereinafter, this feature will be specifically described.

As shown in FIG. 1, the calibration system 1 at least includes calibration tools 11_1 and 11_2, a coupling member 12, calibration target apparatuses 13_1 and 13_2, and an arithmetic processing apparatus 14. Note that the arithmetic processing apparatus 14 and the calibration target apparatuses 13_1 and 13_2 are configured in such a manner that they can communicate with each other by a wire or wirelessly.

The calibration target apparatus 13_1, which is an apparatus on which calibration is to be performed, is configured to be able to detect the calibration tool 11_1. The result of detecting the calibration tool 11_1 by the calibration target apparatus 13_1 is used to estimate internal parameters (distortion) of the calibration target apparatus 13_1 or estimate external parameters (e.g., calculate the relative positional relation between the calibration target apparatus 13_1 and the other calibration target apparatus 13_2).

The calibration target apparatus 13_1 is, for example, one of an RGB camera, a motion capture camera, a thermal camera, a shape acquisition sensor such as Lider or a sonar, a position detection sensor such as Beacon or a Global Positioning System (GPS), and a light-receiving element that is capable of detecting the calibration tool 11_1.

The calibration tool 11_1 is, for example, one of a calibration board that can be detected by an RGB camera, a calibration wand that can be detected by a motion capture camera, a metallic calibration board that can be detected by a thermal camera, an object having a predetermined shape that can be detected by a shape acquisition sensor, a source of positional information that can be detected by a position detection sensor, and a light-emitting element that emits a light that can be received by a light-receiving element.

Note that the calibration board is a board in which a plurality of feature points (markers) that can be detected by the RGB camera are regularly disposed. The calibration wand is a rod-like member in which a plurality of markers that can be detected by a motion capture camera are disposed with predetermined gaps therebetween. The metallic calibration board is a board in which metallic markers made of, for example, cooper, whose temperature is adjusted to a predetermined temperature are regularly disposed so that the metallic calibration board can be detected by a thermal camera.

The calibration target apparatus 13_2, which is an apparatus on which calibration is to be performed, is configured to be able to detect at least the calibration tool 11_2. The result of detecting the calibration tool 11_2 by the calibration target apparatus 13_2 is used to estimate internal parameters of the calibration target apparatus 13_2 or estimate external parameters.

Here, the calibration target apparatus 13_2 is an apparatus which is a type of apparatus different from the calibration target apparatus 13_1. Specifically, the calibration target apparatus 13_1 is, for example, one of an RGB camera, a motion capture camera, a thermal camera, a shape acquisition sensor such as Lider or a sonar, a position detection sensor such as Beacon or a GPS, and a light-receiving element that is capable of detecting the calibration tool 11_2 and is different from the calibration target apparatus 13_1.

The calibration tool 11_2 is, for example, one of a calibration board that can be detected by an RGB camera, a calibration wand that can be detected by a motion capture camera, a metallic calibration board that can be detected by a thermal camera, an object having a predetermined shape that can be detected by a shape acquisition sensor, a source of positional information that can be detected by a position detection sensor, and a light-emitting element that emits a light that can be received by a light-receiving element. However, since the types of the calibration target apparatuses 13_1 and 13_2 are different from each other, the types of the calibration tools 11_1 and 11_2 are different from each other as well.

That is, the calibration tool 11_2 is one of a calibration board that can be detected by an RGB camera, a calibration wand that can be detected by a motion capture camera, a metallic calibration board that can be detected by a thermal camera, an object having a predetermined shape that can be detected by a shape acquisition sensor, a source of positional information that can be detected by a position detection sensor, and a light-emitting element that emits a light that can be received by a light-receiving element that is different from the calibration tool 11_1.

Further, the calibration tool 11_2 is disposed so as to be able to specify the relative position thereof with respect to the calibration tool 11_1. In the example shown in FIG. 1, the calibration tool 11_2 is coupled to the calibration tool 11_1 by the coupling member 12 such as a rigid rod. This coupling member 12 allows the relative positional relation between the first and second calibration tools to be fixed.

The arithmetic processing apparatus 14 calculates the relative position (coordinates) of the calibration target apparatus 13_2 with respect to the calibration target apparatus 13_1 based on the result of detecting the calibration tool 11_1 by the calibration target apparatus 13_1 and the result of detecting the calibration tool 11_2 by the calibration target apparatus 13_2.

Specifically, in the arithmetic processing apparatus 14, first, the relative position of the calibration tool 11_1 with respect to the calibration target apparatus 13_1 is specified from the result of detecting the calibration tool 11_1 by the calibration target apparatus 13_1. Here, the calibration tool 11_1 and the calibration tool 11_2 are coupled to each other in such a way that the relative positional relation therebetween is maintained by the coupling member 12. It is therefore possible to specify the relative position of the calibration tool 11_2 with respect to the calibration target apparatus 13_1. Further, the relative position of the calibration target apparatus 13_2 with respect to the calibration tool 11_2 is specified from the result of detecting the calibration tool 11_2 by the calibration target apparatus 13_2. Accordingly, the relative position of the calibration target apparatus 13_2 with respect to the calibration target apparatus 13_1 is specified.

Note that the arithmetic processing apparatus 14 may be configured to not only calculate the relative position of the calibration target apparatus 13_2 with respect to the calibration target apparatus 13_1 but also estimate the internal parameters of the calibration target apparatus 13_1 from the result of detecting the calibration tool 11_1 by the calibration target apparatus 13_1 or estimate the internal parameters of the calibration target apparatus 13_2 from the result of detecting the calibration tool 11_2 by the calibration target apparatus 13_2.

Further, the arithmetic processing apparatus 14 may be provided, but not limited thereto, in a control apparatus or the like other than the calibration target apparatuses 13_1 and 13_2. The arithmetic processing apparatus 14 may instead be provided, for example, inside the calibration target apparatus 13_1.

### Specific Configuration Example of Calibration System 1

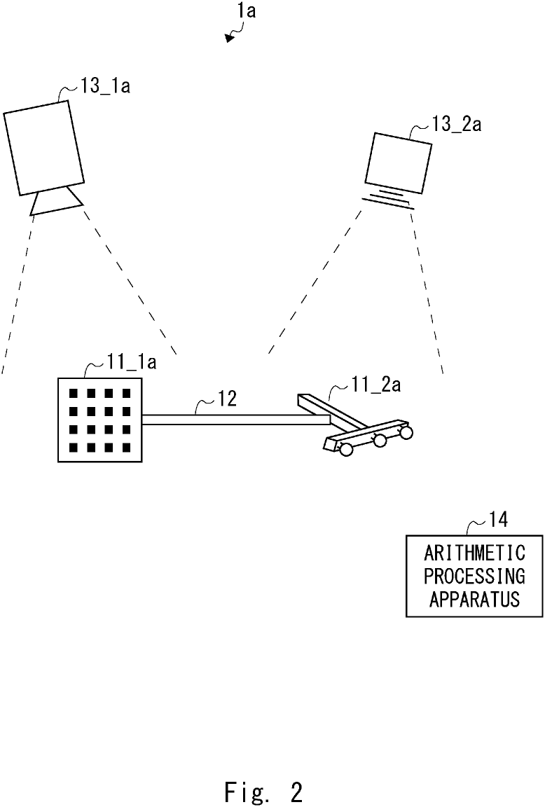

FIG. 2 is a diagram showing a specific configuration example of the calibration system 1 as a calibration system 1a.

In the example shown in FIG. 2, the calibration system 1a includes a calibration board 11_1a as the calibration tool 11_1 and includes a calibration wand 11_2a as the calibration tool 11_2. The calibration board 11_1a and the calibration wand 11_2a are coupled to each other in such a way that the relative positional relation therebetween is maintained by a coupling member 12. Further, the calibration system 1a includes an RGB camera 13_1a capable of detecting the calibration board 11_1a as the calibration target apparatus 13_1, and a motion capture camera 13_2a capable of detecting the calibration wand 11_2a as the calibration target apparatus 13_2.

Note that a combination of types of the calibration tools 11_1 and 11_2 can be changed as desired. Further, a combination of types of the calibration target apparatuses 13_1 and 13_2 can be changed as desired as long as the calibration target apparatuses 13_1 and 13_2 are able to detect the calibration tools 11_1 and 11_2, respectively.

### Operation of Calibration System 1

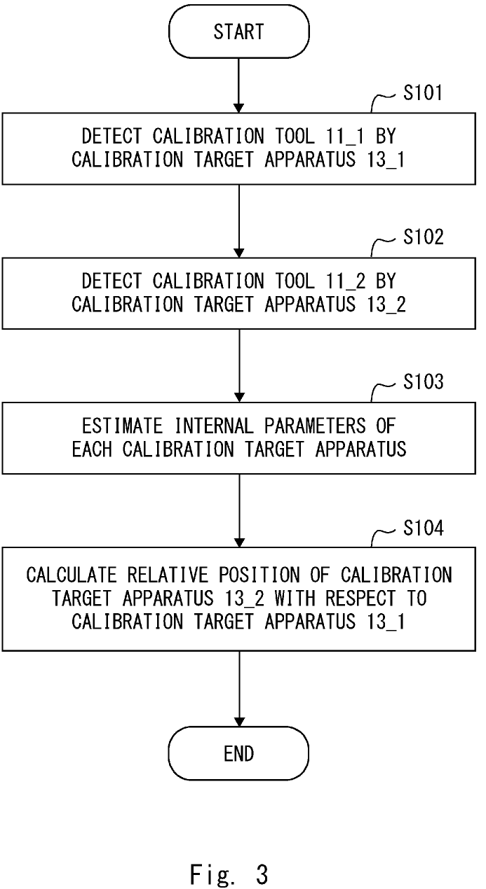

FIG. 3 is a flowchart showing an operation of the calibration system 1.

As shown in FIG. 3, in the calibration system 1, first, the calibration target apparatus 13_1 detects the calibration tool 11_1 (Step S101). In the example shown in the calibration system 1a shown in FIG. 2, the RGB camera 13_1a shoots the calibration board 11_1a.

Further, the calibration target apparatus 13_2 detects the calibration tool 11_2 (Step S102). In the example shown in FIG. 2, the motion capture camera 13_2a shoots the calibration wand 11_2a.

After that, as necessary, internal parameters in each of the calibration target apparatuses 13_1 and 13_2 are estimated (Step S103).

After that, the relative position of the calibration target apparatus 13_2 with respect to the calibration target apparatus 13_1 is calculated based on the results of the detection by each of the calibration target apparatuses 13_1 and 13_2 (Step S104).

In the example of the calibration system 1a shown in FIG. 2, first, the relative position of the calibration board 11_1a with respect to the RGB camera 13_1a is specified from an image of the calibration board 11_1a captured by the RGB camera 13_1a. Here, the calibration board 11_1a and the calibration wand 11_2a are coupled to each other by the coupling member 12 in such a way that the relative positional relation therebetween is maintained. It is therefore possible to specify the relative position of the calibration wand 11_2a with respect to the RGB camera 13_1a. Further, the relative position of the motion capture camera 13_2a with respect to the calibration wand 11_2a is specified from an image of the calibration wand 11_2a captured by the motion capture camera 13_2a. Accordingly, the relative position of the motion capture camera 13_2a with respect to the RGB camera 13_1a is specified.

As described above, the calibration system 1 according to this embodiment further includes, besides the calibration tool 11_1, the calibration tool 11_2 that is installed in such a way that it can specify the relative position thereof with respect to the calibration tool 11_1 and has a type that is different from that of the calibration tool 11_1. Therefore, even in a case in which the types of the calibration target apparatuses 13_1 and 13_2 are different from each other, it is possible to specify the relative position (coordinates) of the calibration target apparatus 13_2 with respect to the calibration target apparatus 13_1.

While the case in which the calibration system 1 specifies the relative positional relation between the two calibration target apparatuses 13_1 and 13_2 has been described in this embodiment, this is merely one example. The calibration system 1 may be configured, for example, so as to specify the relative positional relation among n (where n is an integer equal to or larger than three) calibration target apparatuses 13_1-13_n. In this case, one or more of the calibration target apparatuses 13_1-13_n is configured to be able to detect the calibration tool 11_1 and the remaining ones of the calibration target apparatuses 13_1-13_n are configured to be able to detect the calibration tool 11_2.

### Second Embodiment

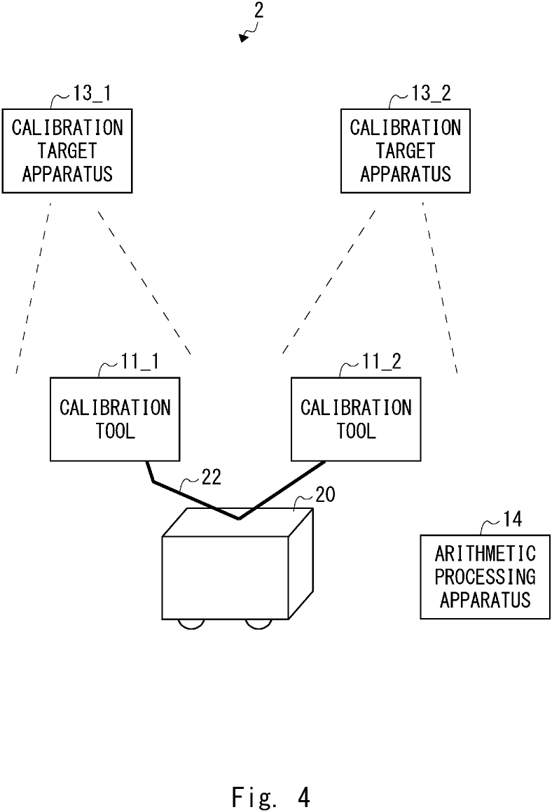

FIG. 4 is a block diagram showing a configuration example of a calibration system 2 according to a second embodiment. The calibration system 2 is different from the calibration system 1 in that the calibration system 2 includes a robot 20 having a robot arm 22 instead of including therein the coupling member 12. An arithmetic processing apparatus 14, calibration target apparatuses 13_1 and 13_2, and the robot 20 are configured in such a manner that they can communicate with one another by a wire or wirelessly.

A calibration tool 11_1 and a calibration tool 11_2 are coupled to each other by the robot arm 22 in place of the coupling member 12. Here, the robot 20 is configured to be able to control the robot arm 22 while grasping its position and angle. Therefore, it is possible to specify the relative positional relation between the calibration tool 11_1 and the calibration tool 11_2 from a status in which the robot 20 controls the robot arm 22.

Accordingly, the calibration system 2 is able to specify the relative position (coordinates) of the calibration target apparatus 13_2 with respect to the calibration target apparatus 13_1, like in the calibration system 1, even in a case in which the types of the calibration target apparatuses 13_1 and 13_2 are different from each other.

Note that the robot 20 may be configured to be able to move. Specifically, the robot 20 may be configured so as to be able to move by a remote operation or may be configured to be able to autonomously move. Accordingly, it becomes easy to install and remove the calibration tools 11_1 and 11_2. Further, the calibration tools 11_1 and 11_2 can be installed in high or narrow places as well, whereby the calibration system 2 can be applied to a complicated environment.

### Third Embodiment

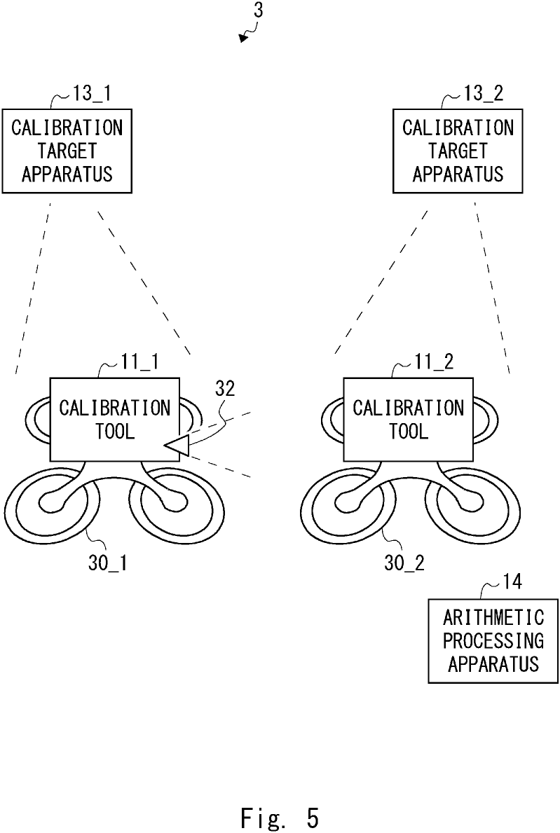

FIG. 5 is a block diagram showing a configuration example of a calibration system 3 according to a third embodiment. The calibration system 3 is different from the calibration system 1 in that the calibration system 3 includes a detection apparatus 32 in place of the coupling member 12. An arithmetic processing apparatus 14, calibration target apparatuses 13_1 and 13_2 and the detection apparatus 32 are configured in such a manner that they can communicate with one another by a wire or wirelessly. Further, in the example shown in FIG. 5, a calibration tool 11_1 is mounted on a flying object (a so-called drone) 30_1, which is one type of a robot, and a calibration tool 11_2 is mounted on a flying object 30_2, which is one type of a robot.

The detection apparatus 32 is attached to the calibration tool 11_1 and detects the calibration tool 11_2, whereby the detection apparatus 32 is configured to be able to specify the relative position of the calibration tool 11_2 with respect to the calibration tool 11_1. The detection apparatus 32 is, for example, an apparatus (e.g., a motion capture camera) which is a type of apparatus the same the calibration target apparatus 13_2.

Accordingly, the calibration system 3 is able to specify the relative position (coordinates) of the calibration target apparatus 13_2 with respect to the calibration target apparatus 13_1 even in a case in which the types of the calibration target apparatuses 13_1 and 13_2 are different from each other, like in the calibration system 1.

Further, the flying objects 30_1 and 30_2 are configured to be able to move, whereby the calibration system 3 is able to achieve effects similar to those obtained when the calibration system 2 is employed. That is, it becomes easy to install and remove the calibration tools 11_1 and 11_2. Further, the calibration tools 11_1 and 11_2 can be installed in high or narrow places, whereby the calibration system 3 can be applied to a complicated environment.

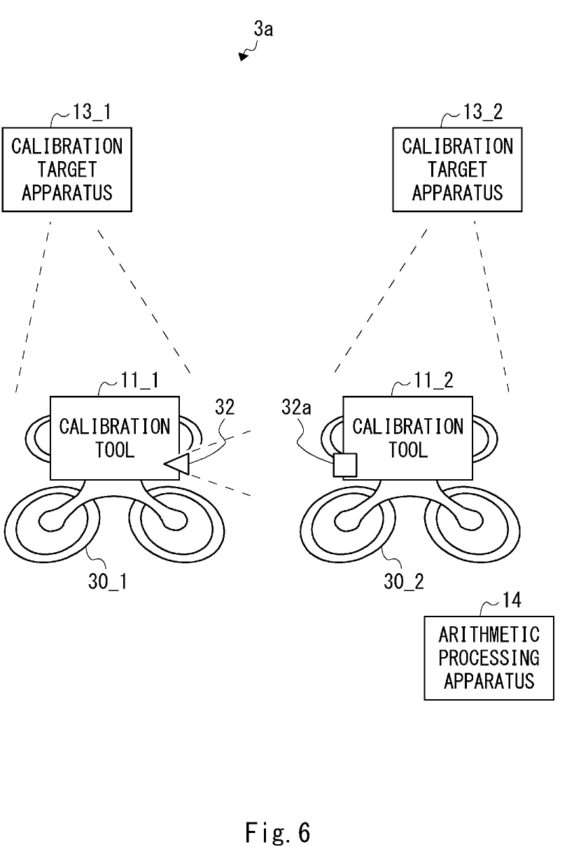

While the case in which the detection apparatus 32 is configured to be able to detect the calibration tool 11_2 has been described as an example in this embodiment, this is merely one example. As shown in a modified example (a calibration system 3a) in FIG. 6, the detection apparatus 32 may be configured to be able to detect a calibration tool 32a attached to the calibration tool 11_2 instead of detecting the calibration tool 11_2.

### Fourth Embodiment

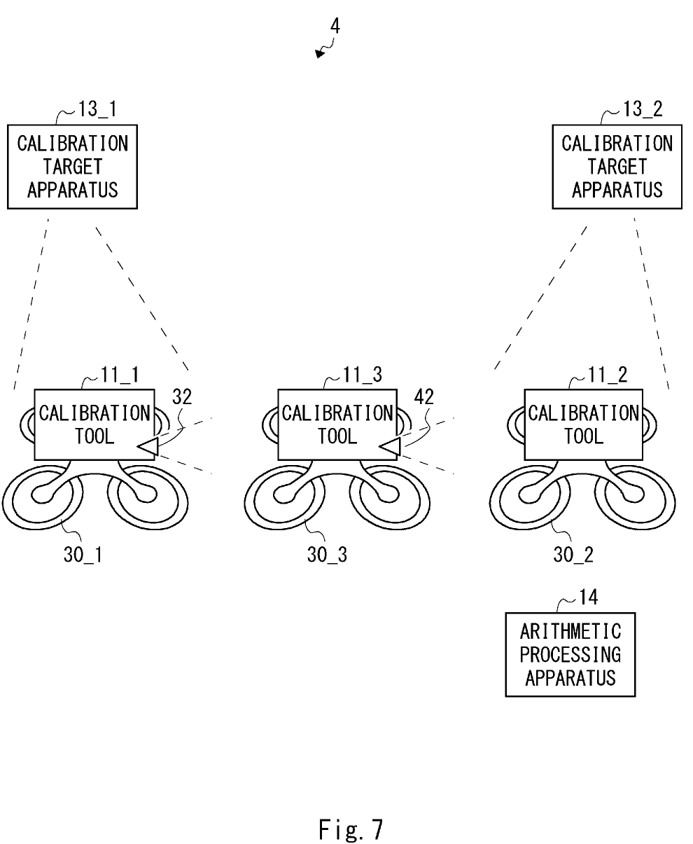

FIG. 7 is a block diagram showing a configuration example of a calibration system 4 according to a fourth embodiment. The calibration system 4 is different from the calibration system 3 in that the calibration system 4 further includes a calibration tool 11_3 and a detection apparatus 42 attached thereto. Further, in the example shown in FIG. 7, the calibration tool 11_3 is mounted on a flying object (a so-called drone) 30_3, which is one type of a robot.

A detection apparatus 32 attached to a calibration tool 11_1 is configured to be able to specify the relative position of the calibration tool 11_3 with respect to the calibration tool 11_1 by detecting the calibration tool 11_3.

The detection apparatus 42 attached to the calibration tool 11_3 is configured to be able to specify the relative position of a calibration tool 11_2 with respect to the calibration tool 11_3 by detecting the calibration tool 11_2.

Accordingly, the calibration system 4 is able to specify the relative position (coordinates) of a calibration target apparatus 13_2 with respect to a calibration target apparatus 13_1 even in a case in which the types of the calibration target apparatuses 13_1 and 13_2 are different from each other, like in the calibration system 1.

Further, since the flying objects 30_1-30_3 are configured to be able to move, the calibration system 4 is able to achieve effects similar to those obtained when the calibration system 2 is employed. That is, it becomes easy to install and remove the calibration tools 11_1-11_3. Further, the calibration tools 11_1-11_3 can be installed in high or narrow places as well, whereby the calibration system 4 can be applied to a complicated environment.

While the case in which the calibration system 4 includes the three calibration tools 11_1-11_3 configured to be able to specify the relative positional relation has been described as an example in this embodiment, this is merely one example. The calibration system 4 may include, for example, m (where m is an integer equal to or larger than four) calibration tools 11_1-11_m configured to be able to specify the relative positional relation.

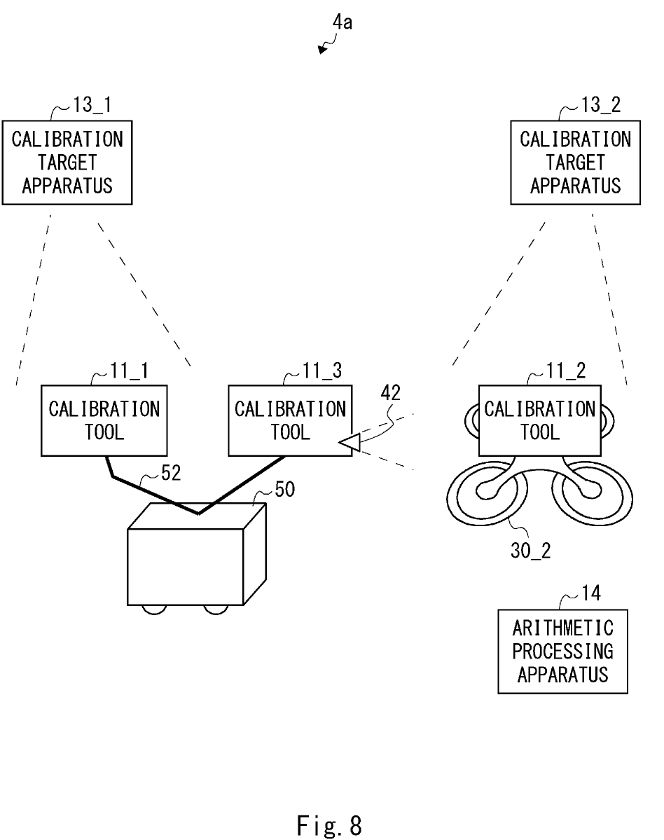

Further, while the case in which the relative positional relation between the calibration tools 11_1 and 11_2 is specified by using the detection apparatus 32 and the relative positional relation between the calibration tools 11_3 and 11_2 is specified by using the detection apparatus 42 has been described as an example in this embodiment, this is merely one example. The relative positional relation among the calibration tools 11_1-11_3 may be specified by using the aforementioned desired method such as a coupling member or a robot arm instead of using the detection apparatuses 32 and 42. Hereinafter, with reference to FIG. 8, one example will be described.

### Modified Example of Calibration System 4

FIG. 8 is a diagram showing a modified example of the calibration system 4 as a calibration system 4a.

The calibration system 4a is different from the calibration system 4 in that the calibration system 4a includes a robot 50 having a robot arm 52 in place of the detection apparatus 32. Further, in the example shown in FIG. 8, a calibration tools 11_1 and 11_3 are coupled to each other by the robot arm 52 instead of being mounted on the flying objects 30_1 and 30_3. Here, the robot 50 is configured to be able to control the robot arm 52 while grasping its position and angle. Therefore, it is possible to specify the relative positional relation between the calibration tool 11_1 and the calibration tool 11_3 from a status in which the robot 50 controls the robot arm 52.

That is, in the calibration system 4a, the relative positional relation between the calibration tools 11_1 and 11_3 is specified by the robot 50 having the robot arm 52 instead of being specified using the detection apparatus 32.

Accordingly, the calibration system 4a is able to achieve effects similar to those in the case in which the calibration system 4 is employed.

As described above, the calibration systems according to the first to fourth embodiments further include, besides the first calibration tool, the second calibration tool that is installed so as to be able to specify a relative position thereof with respect to the first calibration tool, the type of the second calibration tool being different from that of the first calibration tool. Accordingly, even when the types of the first and second calibration target apparatuses are different from each other, the relative position of the second calibration target apparatus with respect to the first calibration target apparatus can be specified.

While the present disclosure has been described as a hardware configuration in the aforementioned first to fourth embodiments, the present disclosure is not limited thereto. The present disclosure is able to achieve the processing of controlling the calibration system by causing a Central Processing Unit (CPU) to execute a computer program.

The aforementioned program includes instructions (or software codes) that, when loaded into a computer, cause the computer to perform one or more of the functions described in the embodiments. The program may be stored in a non-transitory computer readable medium or a tangible storage medium. By way of example, and not a limitation, computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (registered trademark) disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A calibration system comprising:
a first calibration tool;
a second calibration tool that is installed so as to be able to specify a relative position thereof with respect to the first calibration tool, the type of the second calibration tool being different from that of the first calibration tool;
a first calibration target apparatus configured to be able to detect the first calibration tool;
a second calibration target apparatus configured to be able to detect the second calibration tool; and
an arithmetic processing apparatus configured to calculate the relative position of the second calibration target apparatus with respect to the first calibration target apparatus based on the result of detecting the first calibration tool by the first calibration target apparatus and the result of detecting the second calibration tool by the second calibration target apparatus.

2. The calibration system according to claim 1, wherein
the first calibration target apparatus is at least one of an RGB camera, a motion capture camera, a thermal camera, a shape acquisition sensor, a position detection sensor, and a light-receiving element, and
the second calibration target apparatus is one of an RGB camera, a motion capture camera, a thermal camera, a shape acquisition sensor, a position detection sensor, and a light-receiving element that is different from the first calibration target apparatus.

3. The calibration system according to claim 1, further comprising a coupling member configured to couple the first calibration tool to the second calibration tool.

4. The calibration system according to claim 1, further comprising a robot configured to couple the first calibration tool to the second calibration tool by a robot arm.

5. The calibration system according to claim 1, wherein the first calibration tool is provided with a detection apparatus configured to be able to specify a relative position of the second calibration tool with respect to the first calibration tool by detecting the second calibration tool.

6. The calibration system according to claim 5, further comprising:
a first robot on which the first calibration tool is mounted; and
a second robot on which the second calibration tool is mounted.

7. The calibration system according to claim 6, wherein at least one of the first and second robots is configured to be able to move.

8. The calibration system according to claim 1, further comprising a third calibration tool, wherein
the first calibration tool is provided with a first detection apparatus configured to be able to specify a relative position of the third calibration tool with respect to the first calibration tool by detecting the third calibration tool, and
the third calibration tool is provided with a second detection apparatus configured to be able to specify a relative position of the second calibration tool with respect to the third calibration tool by detecting the second calibration tool.

9. The calibration system according to claim 8, further comprising:
a first robot on which the first calibration tool is mounted;
a second robot on which the second calibration tool is mounted; and
a third robot on which the third calibration tool is mounted.

10. The calibration system according to claim 9, wherein at least one of the first to third robots is configured to be able to move.

11. A method for controlling a calibration system comprising:
a first calibration tool;
a second calibration tool that is installed so as to be able to specify a relative position thereof with respect to the first calibration tool, the type of the second calibration tool being different from that of the first calibration tool;
a first calibration target apparatus configured to be able to detect the first calibration tool;
a second calibration target apparatus configured to be able to detect the second calibration tool; and
an arithmetic processing apparatus, the method comprising:
detecting the first calibration tool by the first calibration target apparatus;
detecting the second calibration tool by the second calibration target apparatus; and
calculating, using the arithmetic processing apparatus, the relative position of the second calibration target apparatus with respect to the first calibration target apparatus based on the result of detecting the first calibration tool by the first calibration target apparatus and the result of detecting the second calibration tool by the second calibration target apparatus.

12. A non-transitory computer readable medium storing a control program of a calibration system, the calibration system comprising:
a first calibration tool;
a second calibration tool that is installed so as to be able to specify a relative position thereof with respect to the first calibration tool, the type of the second calibration tool being different from that of the first calibration tool;
a first calibration target apparatus configured to be able to detect the first calibration tool;
a second calibration target apparatus configured to be able to detect the second calibration tool; and
an arithmetic processing apparatus, the control program causing a computer to execute the processing of:
detecting the first calibration tool by the first calibration target apparatus;
detecting the second calibration tool by the second calibration target apparatus; and
calculating, using the arithmetic processing apparatus, the relative position of the second calibration target apparatus with respect to the first calibration target apparatus based on the result of detecting the first calibration tool by the first calibration target apparatus and the result of detecting the second calibration tool by the second calibration target apparatus.
